(19) United States
(12) Patent Application Publication
(10) Pub. No.: US 2008/0044012 A1
(43) Pub. Date: Feb. 21, 2008

(54) Reducing Security Protocol Overhead In Low Data Rate Applications Over A Wireless Link

(75) Inventors: Jan-Erik Ekberg, Vantaa (FI); Antti Lappetelainen, Espoo (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/464,626

(22) Filed: Aug. 15, 2006

(51) Int. Cl. H04L 9/30

(52) U.S. Cl. 380/30

(57) ABSTRACT

A wireless communication module to provide security at a baseband layer is disclosed. A payload of plaintext may be divided into partitions. The module may use a block cipher such as the Advanced Encryption Standard (AES) algorithm to process a unique initiation vector (IV) for each partition so that each partition may be XORed with a key stream based on a respective IV, the result providing ciphertext. The IV may include a nonce, an upper level packet counter, a packet counter and a block counter. The state of the counters may be incremented in a predetermined pattern so as to provide a unique IV for use with each partition. The ciphertext may be transmitted in a packet with a security bit indicating that the payload is encrypted but omitting the nonce. Encrypted packets may include an integrity check value (ICV) to provide for integrity of the encrypted message.

### FIELD OF INVENTION

The invention relates to security in wireless communication networks, more particularly to providing security at a baseband level.

### BACKGROUND

In a full operation mode, a low-rate radio communication module requires communication with a host module that controls the operation and data flow between the host module and the low-rate radio communication module. A host interface is usually implemented as a serial interface, such as a serial peripheral interface (SPI), a universal asynchronous receiver/transmitter (UART), or other similar interface. However, in some cases, communication modules can also operate without any control from a host module. In such cases, the data flow and/or operation mode is limited in some extent in comparison with a full operation mode. For example, data transmitted by a communication module might be constant so no data flow from a host module to a communication module is needed. Also, the behavior of a communication module may be constant which makes the existence of a controlling host module unnecessary. However, for initialization, operation control, and communication control, a host module has always been required.

In some cases, a default operation requires the existence of a host module that can offer complete control of data flow. On the other hand, the existence of a complete host module is not necessary if the application or the use does not necessitate it. In some cases, a very low amount of varying data is transferred on the radio interface in one packet and a duty cycle may be very low as well. At a minimum, payload information, such as a sensor value, might be only one bit or a byte, and in some applications, a packet frame containing an identification (ID) of a device indicating the existence of a device inside of a communication range is sufficient. As such, reduced host functionality/implementation is appropriate although the lower layers in the full extent are required.

Currently, a host interface, such as an Upper Layer Interface (ULIF), of a communication module, such as a Bluetooth Low End Extension (BT-LEE) module, does not support different modes of operation. A host module and its active control exist for a default ULIF mode. However, implementations that target to extremely low power and simple applications requiring less power consumption of a host module are lacking. BT-LEE technology allows small devices to connect to other devices, such as mobile terminals, without the power and cost burden of traditional Bluetooth technology. Typical small devices include sensors, such as temperature sensors, toys, wireless pens, headsets, and other remote user interface peripherals. Further information regarding BT-LEE technology is described in Mauri Honkanen et al., “Low End Extension for Bluetooth,” IEEE Radio and Wireless Conference RAWCON 2004, Atlanta, Ga., September 2004, pages 19-22.

Conventionally, devices with a short-range radio connectivity capability are implemented so that a host layer or unit, e.g. a micro-controller, controls the Medium Access Control (MAC) layer of a wireless communication module. FIG. 1 illustrates a conventional communication module 101. For example, when utilizing Bluetooth technology, interface 103 between a host layer or unit 105 and the MAC layer 107 is referred to as a Host Controller Interface (HCI). When utilizing BT-LEE technology, interface 103 is referred to as an Upper Layer Interface (ULIF). In relatively simple applications, a host layer 105 is not mandatory from the perspective of communication. As such, the functionality of host layer 105 can be significantly cut down. Additionally, the limited power resources of small devices necessitate that power consumption be minimized and pressure to minimize manufacturing costs drive manufacturers to develop simpler implementations. Therefore, it would be advantageous to minimize the requirements for a host layer.

While minimizing the requirements of a host layer has certain advantages, it should be noted that there are a number of basic security threats common to wireless communication. One threat is the potential that a device may masquerade as an authorized device, thus gaining unauthorized access to resources. Another threat is that an unauthorized device may receive a transmission, potentially allowing for unauthorized disclosure of the data. Yet another threat is that an unauthorized device can attempt to address a device and gain unauthorized use of a resource. Other threats include interruption of data integrity and interruption of service through the use of interference.

Therefore, certain uses of BT-LEE would benefit from the inclusion of a security protocol such as Advanced Encryption Standard (AES) in a MAC layer, so as to provide confidential transmission of data.

### SUMMARY

Aspects of the present invention are related to a new communication protocol, BT-LEE (low end extensions for Bluetooth), which is related to Bluetooth technology and aims at providing a simplified low rate communication. In an embodiment, a security module may be provided to encrypt plaintext at a baseband level. A block cipher, which may be 128 bits, may be used with a control block so as provide encryption. The control block may include a nonce, an upper level packet counter, a packet counter and a block counter. States of the counters of the control block may be incremented in a predetermined fashion so as to allow for the provision of a unique control block or initiation vector (IV) that may be readily processed in the cipher algorithm so as to allow encryption and decryption without the need to send the nonce with each packet. In an embodiment, a cyclic redundancy check (CRC) may be replaced with an integrity check value (ICV) for packets that are encrypted and the ICV may be based on an IV with a zero value block counter.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates an example of a conventional wireless communication module;

FIG. 2 illustrates an embodiment of a system of wireless communication modules in communication in accordance with at least one aspect of the present invention;

FIG. 2a illustrates another embodiment of a system of wireless communication modules in communication in accordance with at least one aspect of the present invention;

FIG. 2b illustrates another embodiment of a system of wireless communication modules in communication in accordance with at least one aspect of the present invention;

FIG. 3 illustrates a block diagram of a state machine of a BT-LEE MAC layer in accordance with at least one aspect of the present invention;

FIG. 4 illustrates an exemplary embodiment of a method for providing encrypted data between a poller and a polled device in accordance with at least one aspect of the present invention;

FIGS. 5-6 illustrate embodiments of formats of packets that can be transmitted in accordance with at least one aspect of the present invention;

FIG. 7 illustrates an embodiment of a format of a ID-packet that may be transmitted with the format depicted in FIG. 5 in accordance with at least one aspect of the present invention;

FIG. 8 illustrates an embodiment of a format of a DATA-packet that may be transmitted with the format depicted in FIG. 6 in accordance with at least one aspect of the present invention;

FIG. 9 illustrates an embodiment of a header format that may be used in the DATA-packet depicted in FIG. 8 in accordance with at least one aspect of the present invention;

FIG. 10 illustrates an embodiment of a payload format that may be used with a MAC control packet in accordance with at least one aspect of the present invention;

FIG. 11 illustrates an embodiment of a control block format that may be used as an initiation vector;

FIG. 12 illustrates an exemplary embodiment of a process of using an initiation vector to generate ciphertext that may be used in accordance with at least one aspect of the present invention; and

FIGS. 13-13a illustrate embodiments of exemplary initiation vectors formats that may be used in accordance with at least one aspect of the present invention.

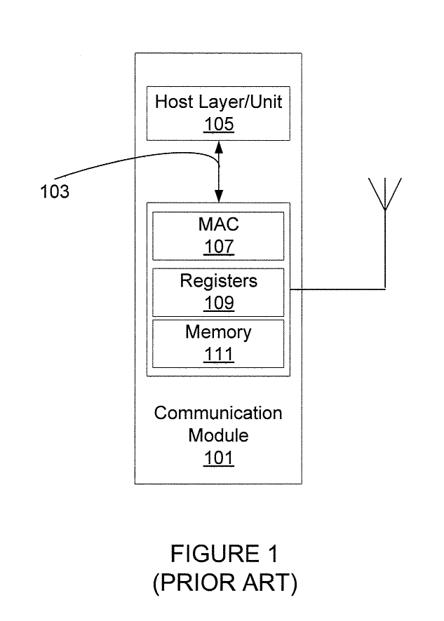

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

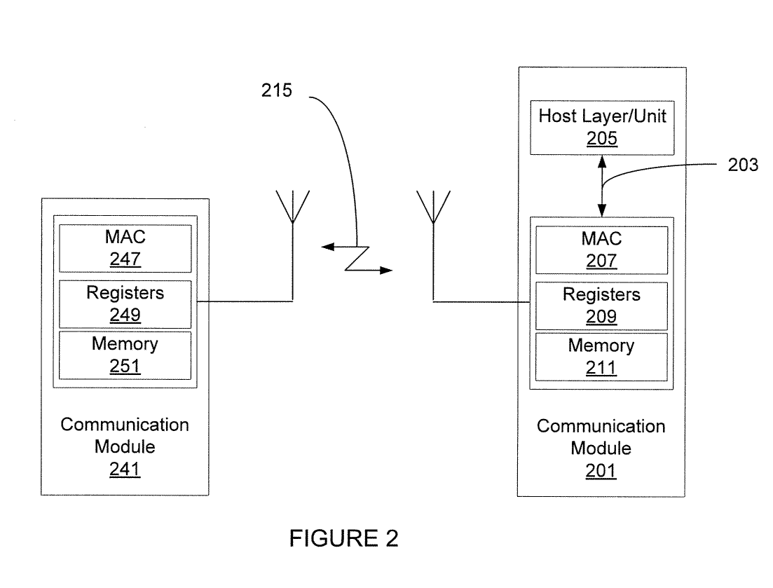

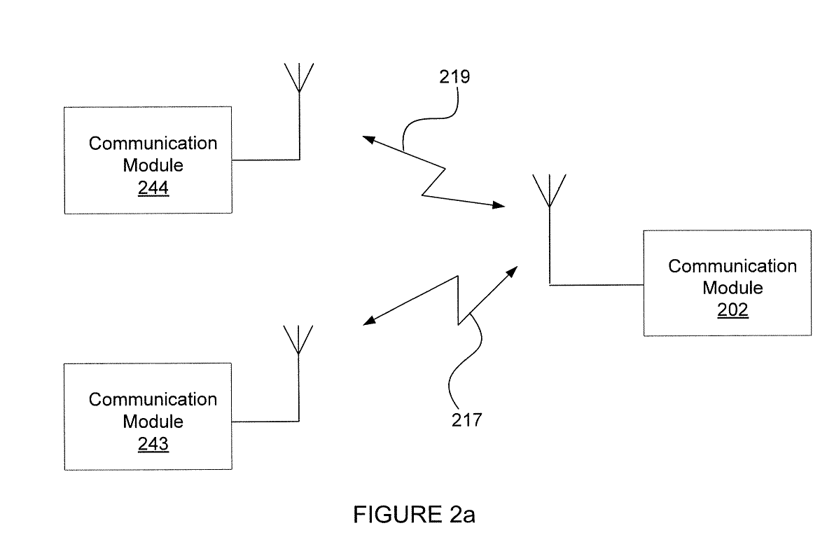

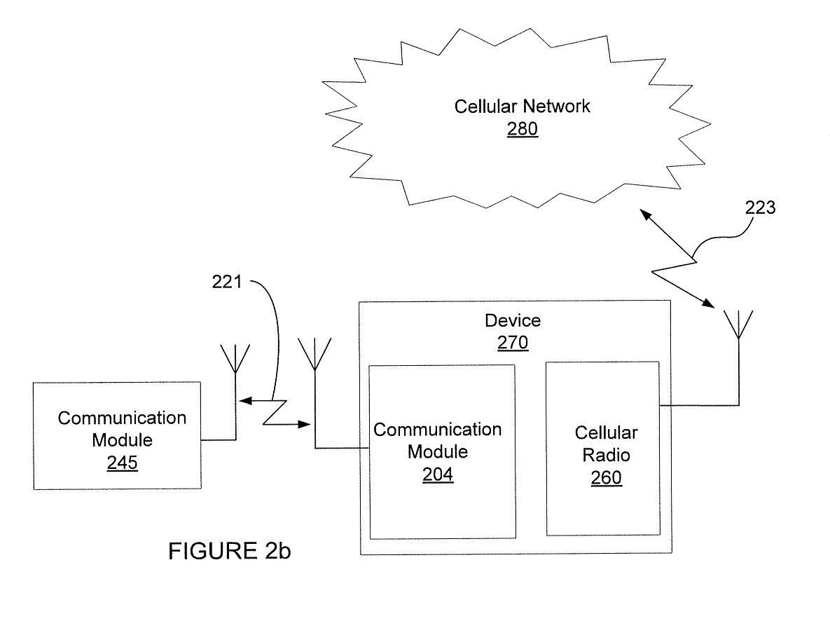

As shown in FIG. 2, communication module 201 includes an interface 203 between a host layer or unit 205 and a MAC layer 207. Communication module 201 is also shown to include register 209 and a memory space 211. In an embodiment, the registers 249 and memory 251 of a communication module 241 may be accessed over an air interface 215 without the existence or any actions from a host layer in that module. The host layer or unit 205 of communication module 201 can handle the functions of the over the air interface 215 for the host layer of communication module 241 and is in communication with the communication module 241 (via the air interface 215 between the MAC layers of the communication modules 201 and 241). In such a configuration, no host processor is needed in communication module 241, and communication module 241 may be run in simplified host or host-less mode. Access to register 249 and memory 251 over air interface 215 also allows the use of communication module 241 in a mode that is similar to radio frequency identification (RFID) tag technology.

FIG. 2a illustrates an embodiment with a communication module 202 communicating with communication module 243 via air interface 217 and with communication module 244 via air interface 219. Thus, FIG. 2a illustrates an example of point to multi-point broadcasting. As can be appreciated, each of the modules 202, 243, 244 may be configured as module 201 or module 241 (as shown in FIG. 2), thus allowing a number of different system configurations. Furthermore, additional modules (which are not shown for reasons of clarity) may be added as desired.

FIG. 2b illustrates an alternative embodiment where a device 270, which may be a cellular phone or some other device, includes a communication module 204 that is in communication with communication module 245 via an air interface 221. As depicted, the device further includes a cellular radio 260 that is in communication with a cellular network 280 via air interface 223. Thus, device 270 is an embodiment of a dual-mode device and while a cellular radio is depicted, over known radios may also be used. As can be appreciated, various combinations of dual-mode devices and point-to-point or point-to-multipoint are possible. Thus, the illustrated configurations are merely representative and numerous variations are contemplated. For the sake of brevity, however, additional variations of the depicted embodiments will not be described.

It should be noted that the amount of control exercised by upper layers through the ULIF interface may depend on the nature of the device. For example, in certain simple devices there may be no need for security and therefore the data overhead associated with providing security is not at issue. For other devices, the upper layers may provide security. However, for certain devices it is preferable to minimize upper layer activity because it is not otherwise needed or desired. In such devices, having security provided in the baseband level can allow for more cost effective and or energy efficient implementation of security on a device. If the power usage for providing the security in the baseband layer can also be reduced, the ability to provide such security becomes even more attractive.

MAC State Machine

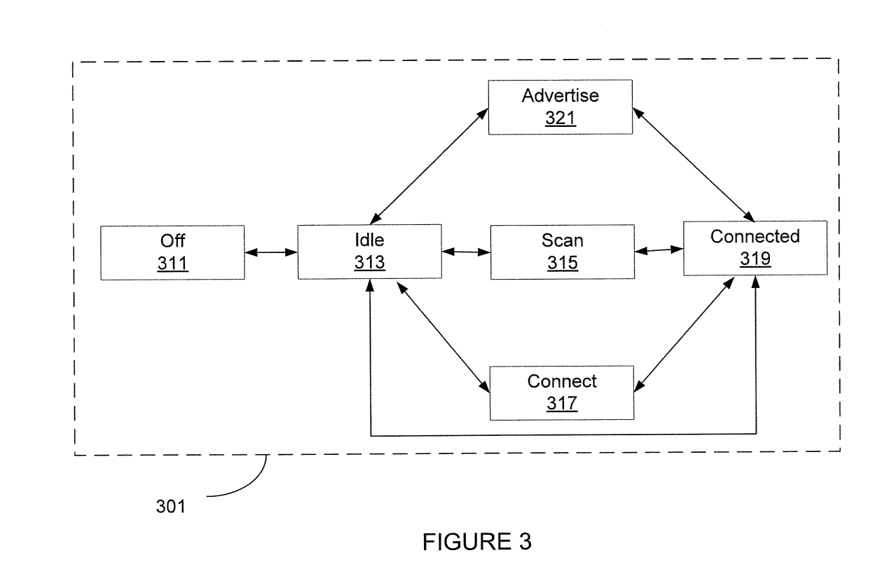

A state machine of BT-LEE MAC functionality is illustrated by the components 311, 313, 315, 317, 319 and 321 within the broken line box 301 as shown in FIG. 3. The ability to transfer between different states may differ depending on the role of the device and can vary between devices, thus, for example, certain devices may not have the capability to enter the advertise state.

As depicted, a device, when it initially starts, shifts from an off state 311 to an idle state 313 and can shift to any state from the idle state 313, however the device takes no actions on the air interface while in idle state 313. If the device moves to an advertise state 321, the device can periodically broadcast a ID-INFO advertising message that is visible to devices in scan state 315 or connect state 317. A device in the scan state 315 listens to broadcast messages. A device in connect state 317 can initiate a connection setup with the advertising device and is referred to as an initiator device. From the scan and connect states 315, 317, a device can then shift to a connected state 319 with the advertising device, which will also shift to a connected state 319. Once in the connected state 319, a device can shift back to the four other states as appropriate.

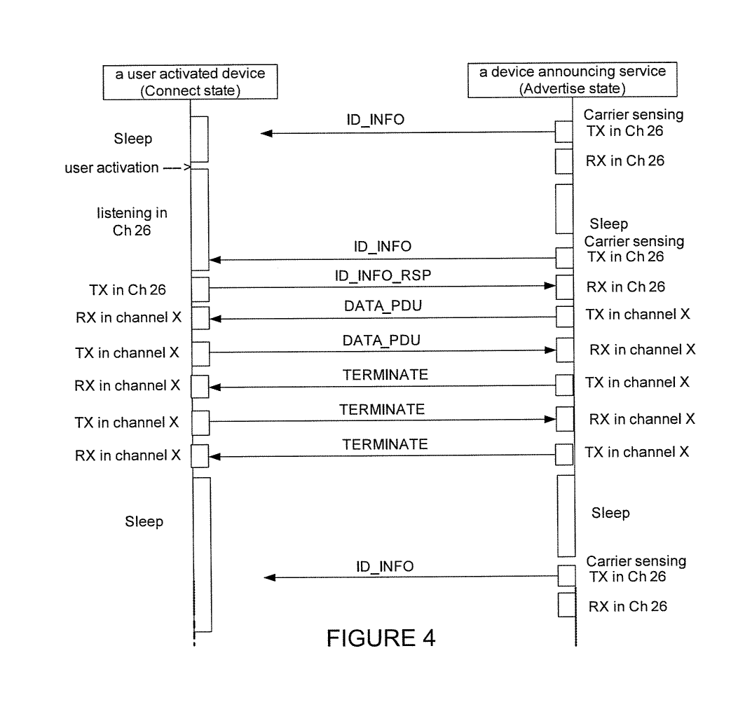

FIG. 4 illustrates an exemplary embodiment of how a device can shift between states. As can be appreciated, the user activated device is initially sleeping (which may be equivalent to the off or idle state) but upon user activation moves to a connect state. Once a connection is made, data is transmitted and received over the selected data channel and then the device terminates the connection and again enters sleep mode. As can be appreciated from the above state diagram in FIG. 3, however, numerous other variations are possible.

New Packets

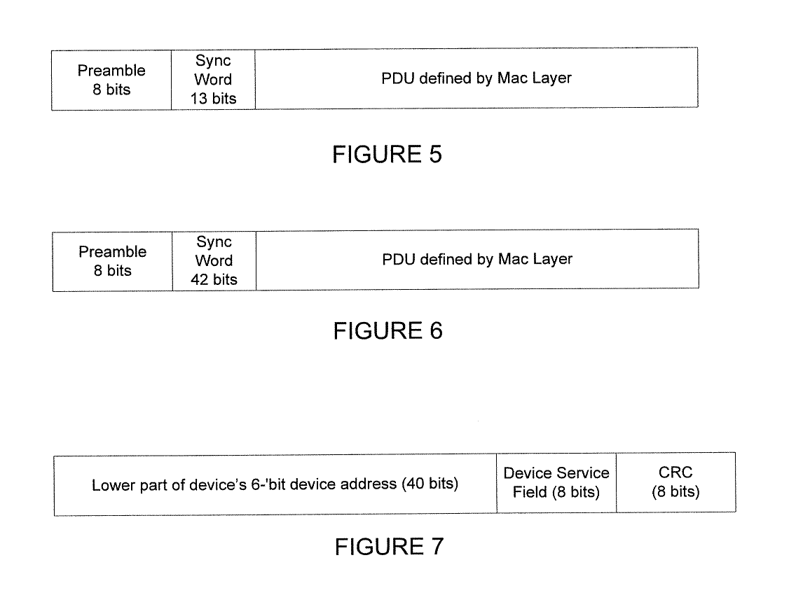

In BT-LEE technology, the MAC layer packet may be preceded by a preamble and a sync word, as shown in FIGS. 5 and 6. The preamble may be used to perform frequency synchronization while the sync word depends on the type of packet. If the baseband level packet is an ID-packet, the sync word may be a 13 bit Barker code, as shown in FIG. 5. If the packet is a DATA-packet, the sync word may be 2 zero bits followed by a 40 bit portion of the 64 bit device address (in an embodiment the 40 bits may be the least significant bits of the 64 bit device address) as shown in FIG. 6.

If the packet is an ID-packet, the format depicted in FIG. 7 may be used for the PDU defined by the MAC portion of FIG. 5. The device service field may include 1 bit that indicate whether role switching is enabled and another indicating whether the device supports security. If 8 bits are used, the remainder of the bits can be used or reserved for other purposes, as desired.

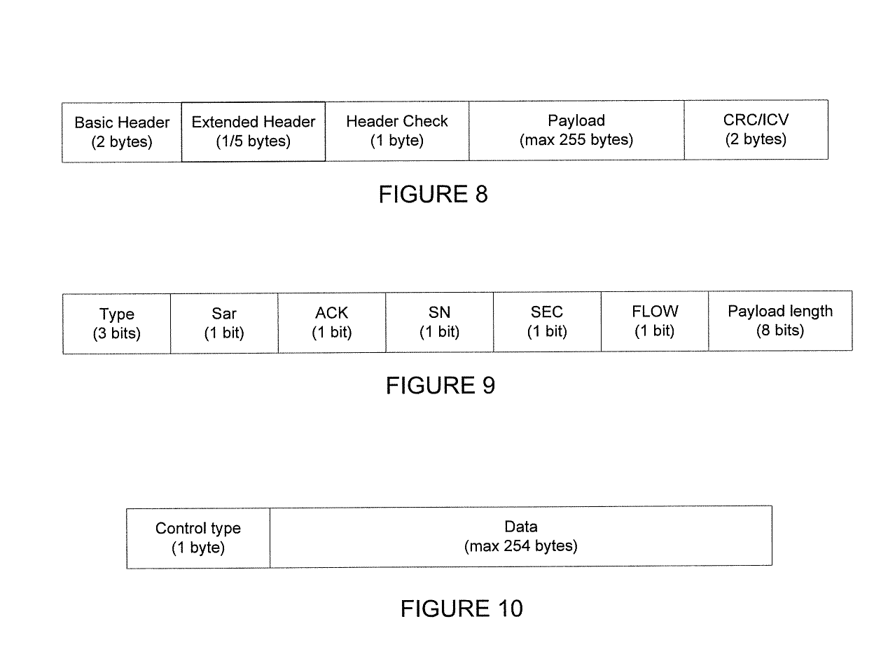

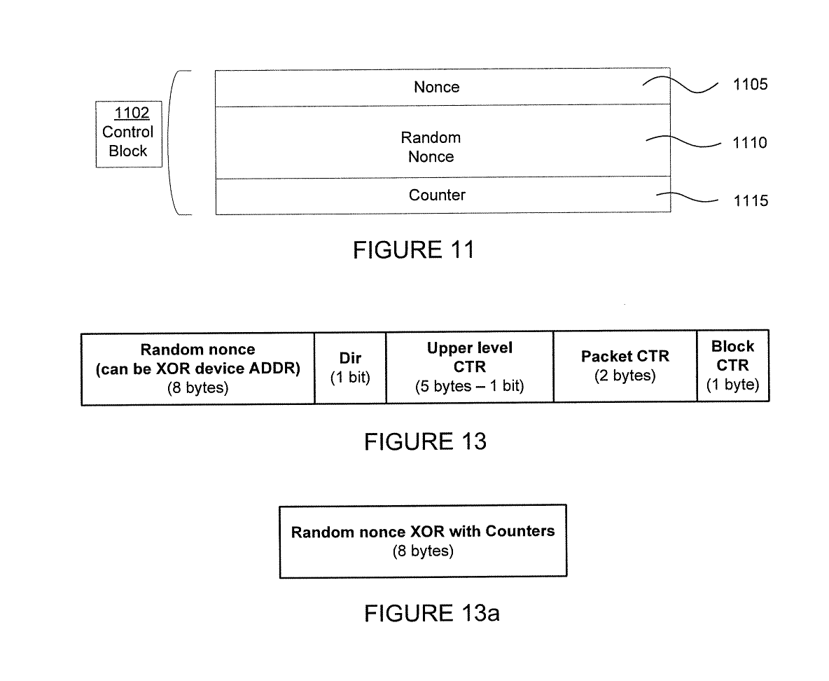

If the packet is a DATA-packet, the PDU depicted in FIG. 6 may include a format as illustrated in FIG. 8, where FIG. 9 illustrates an exemplary format of the basic header. It should be noted that the 1 byte header check, if provided (which may be formed using a typical CRC algorithm) may be formed using the polynomial x⁸+x⁵+1 so as to provide additional header reliability. Looking at FIG. 9, the Type field may be used to represent data packets without an extended header, data packets with an extended header, data packets with a short extended header, MAC control without an extended header, MAC control with an extended header, and MAC control with a short extended header. The SAR bit indicates whether the packet is at the end of a higher layer data packet (or the beginning/middle of such a packet). The ACK bit indicates whether the last data packet was correctly received (i.e. the packet was received with the correct CRC value). The SN bit is used to indicate whether the packet is the first packet sent in a data channel. The SEC bit indicates whether the packet is encrypted or not. The SEC bit can also be used to indicate that the CRC has been replaced with an integrity check value (ICV). The FLOW bit is used to indicate the status of the RX-buffer (e.g., whether new data is allowed). The Payload length field indicates the number of bytes (0-255) of payload.

DATA-packets may be represented by a value of 0, 1, or 2 in the Type field to indicate which what type of header is being used (non-extended, long-extended, and short-extended). The long-extended header may be use by poller devices to transmit data in sniff mode, to poll and acknowledge, if there are multiple polled devices in the sniff, the sniff poll is delayed or the poller indicates additional data transmission.

MAC control packets may use a similar format with the values 3, 4, and 5 representing the type of header being used (non-extended, long-extended, and short-extended). The MAC control packet further includes a format for the payload section, with 1 byte for a control type and up to 254 bytes for data (as depicted in FIG. 10). While the control type byte allows for additional messages as desired, the control type includes a value for a ID_INFO_RSP message, a TERMINATE message, a SNIFF_REQ message, a SNIFF_RSP message, a KEY_UPDATE message, a SESSION_REFRESH message, an ID_FEATURES_MAP message, a CONNECTION_FEATURES_MAP message, a FLUSH message and an UNKNOWN_RSP message. The SESSION_REFRESH message is used to communicate an 8-byte nonce that may be used in packet protection as will be discussed below and the 8-byte nonce may be obtained from an upper level layer.

As is known, the data payload can include data whitening so as to avoid long sequences of 0 bits or 1 bits. In an embodiment, the data whitening may be done after the CRC is calculated on the transmission side and before error check calculation on the receiver side.

The CRC calculation, which may be based on the CRC16 CCITT algorithm using the X¹⁶+x¹²+x⁵+1 polynomial (based on the X25 standard), can be done over the entire 48 bits of the device address field and device service field depicted in FIG. 13 for ID-packets. For DATA-packets, the algorithm can be done over the payload augmented with 16 bits of zeros appended at the end. As will be appreciated from the discussion provided below, the CRC algorithm may be modified so as to provide the ICV.

Once the packet is received, the payload with the appended CRC can then be run through the CRC algorithm to verify that no errors exist. If an error is detected, the ACK bit in the header of the response packet can be set to zero.

Security Considerations

There are a number of basic security threats common to wireless communication. One threat is the potential that a device may masquerade as an authorized device, thus gaining unauthorized access to resources. Another threat is that an unauthorized device may receive a transmission, potentially allowing for unauthorized disclosure of the data. Yet another threat is that an unauthorized device can attempt to address a device and gain unauthorized use of a resource. Other threats include interruption of data integrity and interruption of service through the use of interference.

While a number of methods have been used to address some of the above concerns, data confidentiality typically requires some sort of encryption of the data before transmission. A number of encryption algorithms exist and may be used. For example, one popular encryption algorithm is a block cipher and an example of the block cipher is an Advanced Encryption Standard (AES) algorithm. Of course, other encryption algorithms are also suitable to encrypt data. Furthermore, other block ciphers, such as, but not limited to, Twofish may also be used in place of the AES block cipher. One advantage of the AES block cipher is that it has been tested and no known attacks have proven able to compromise the encryption with current technology. Furthermore, AES is a recognized standard in encryption and has been widely adopted. Thus, the accepted security of AES (at least in view of current technology) makes it suitable for use in devices that require a relatively robust security measure. In particular, AES-Counter (AES-CTR) is well suited to use in a wireless security protocol that streams data. For ease of discussion, a 128-bit implementation will be described below with the understanding that other size bit implementations such as 192-bits or 256-bits are also contemplated.

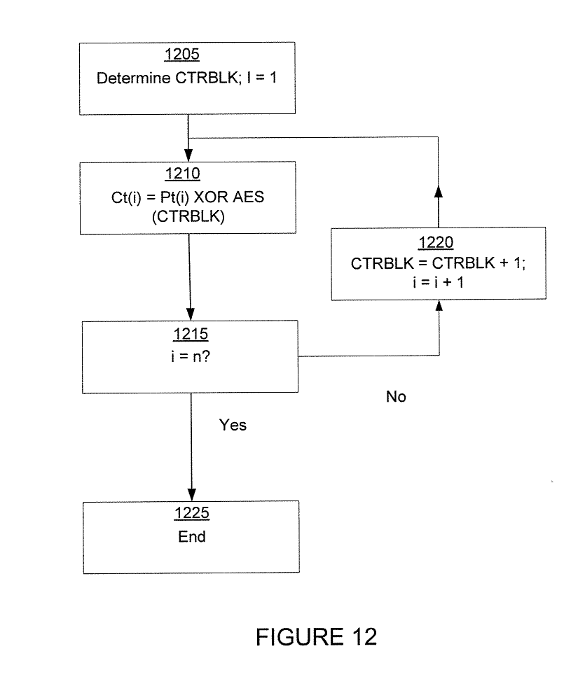

As is known, AES-CTR uses a unique per-packet value (or control block) to encrypt a payload of plaintext. In an embodiment, a 128-bit control block 1102 is generated by using a 32-bit nonce 1105, a 64-bit random nonce 1110 and a 32-bits counter 1115 that is incremented for each control block, as depicted in FIG. 12. In an embodiment, the nonce 1105 is generated when two devices become associated and the random nonce 1110 is randomly determined by a desired method (and typically provided via the ULIF) so that the poller device may transmit it. To encrypt data, a payload of plaintext (data that is to be encrypted) is divided into 128-bit partitions:

Plaintext(Pt)=Pt(1); Pt(2); . . . Pt(n) (where P(n) is less than or equal to 128 bits)

Then each partition is encrypted to form ciphertext in a process depicted in FIG. 12. First the control block (CTRBLK) is determined in step 1205 and i is set equal to 1. The CTRBLK can be the AES control block, of which an embodiment is further discussed below. Then in step 1210, ciphertext Ct(i) is determined for Pt(i) , where i=1 to n. This is accomplished by running the CTRBLK, which is an example of an initiation vector, through the encryption algorithm, which may be the AES algorithm, to obtain a key stream and then XORing the resultant key stream with the partition Pt(i). Next in step 1215, a check is made to see if “i” is equal to “n”. If not, in step 1220, the control block and “i” are incremented (the control block being incremented by incrementing the counter 2515) and step 1210 is repeated. If “i” is equal to “n,” then in step 1225, the encryption process for the packet ends and the ciphertext can then be sent. It should be noted that if the final partition (the n partition) is less than 128 bits, the key stream used in generating ciphertext can be truncated before being XORed with the plaintext. To ensure that each block can be decrypted, the random nonce 1110 is sent with each packet. As the security functionality is typically performed at a higher level (e.g. above the baseband layer) and as the reuse of the random nonce 1110 with the nonce 1105 and counter 1115 exposes the plaintext, in an embodiment, a new random nonce 1110 is provided for each higher level packet. It should be noted that in general a random nonce, such as the random nonce 1110, may be provided via a known procedure such as a random number generator or via known methodologies such as the Internet Key Exchange (IKE) and IKEv2.

While the above method for implementing AES-CTR is relatively secure, assuming authentication issues are handled with a message authentication code, one problem is that it places a relatively high burden on devices that send data relatively infrequently and at potentially lower data rates. As can be appreciated, security can be provided by using a processor at the baseband layer (where the processor may be one or more processors). However, with a BT-LEE devices operating in simplified mode, the need to transmit the random nonce 1110 with each higher level packet places a substantial burden on the device and may significantly reduce the potential lifecycle of a device for a given energy storage device, especially if only a couple of bits of data are being sent. Furthermore, it would be beneficial to allow the security to be provided for in the baseband level because certain BT-LEE devices do not require much in the way of upper level functionality.

Therefore, to address these concerns, in an embodiment the random nonce can be transmitted intermittently and stored in memory of a device. It should be noted that the memory may comprise one or more distinct types and physical locations on the device, thus the term memory is used to generally refer to the memory on the device unless otherwise noted. In an embodiment, the format of the control block may be as disclosed in FIG. 13. The format includes a field for a 64-bit random nonce, a field for a 1-bit direction indicator, a field for a 39-bit upper level packet counter, a field for a 16-bit packet counter (e.g. the MAC level packet counter) and a field for an 8-bit block counter. In an embodiment, a 64-bit random nonce is provided by a poller device and when received by a polled device, the random nonce is XORed with the address of the polled device. As can be appreciated, this allows for point to multi-point communication because a single random nonce provided to difference devices would allow each device to generate a unique value for the random nonce field that could be calculated by both the poller device and the polled device.

The direction (Dir) bit indicates the direction of travel of the packet and in an embodiment may be set to 1 if originating from the poller and 0 if originating from one polled device. The upper level packet counter is incremented for each packet transmitted with SAR=0 (e.g., for each upper level packet). It is also reset when a new nonce is sent, for example, in a SESSION_REFRESH PDU. Incrementing the upper level packet counter resets the packet counter, which corresponds to the number of lower level packets in an upper level packet. The packet counter is reset when SAR=0 and increments for each packet sent where SAR is not=0. The packet counter may also increment for packets that are treated as a sub-block. In an embodiment, the counters for the poller device and the polled device may be provided in two sets, one for transmission and one for reception, so that each set of counters are separately incremented for transmission from the poller and the polled device. Alternatively, a single set of counters may be used for both directions so that each block of encrypted data sent increments one at least one of the counters but the direction bit is updated based on the next packet sent or received.

Within each packet, the block counter may be set at zero and the initiation vector (IV)—(which is also known as the control block in a block cipher algorithm) associated with the zero-value block counter state may used to establish an integrity check value (ICV). In other words, the CRC may be substituted with an ICV/CRC to provide integrity and authentication along with the error checking provided by the CRC. The remaining values 1-255 for the block counter may be used to sequentially encrypt the partitions of plaintext in 128-bit blocks. Of course, some other order of incrementing may also be used. Each subsequent IV is processed through the encryption algorithm (which may be a block cipher such as the AES block cipher (with 10 rounds)), to form a key stream and the key stream is XORed with the respective 128-bits of plaintext to create the 128-bits of ciphertext. Thus, if the first data sent was a payload of plaintext of 2400 bits, it would be sent over one packet and the first packet would include 19 blocks of ciphertext (with the last block potentially being truncated). Furthermore, the IV for the last block encrypted in the second packet could have the previously provided random nonce (which may be XORed with the 64-bit device address value if desired), a value of “0” for the dir bit, a value of “1” for the upper level counter (where the upper level counter may be 39 bits, a value of “1” for the packet counter (which may 16 bits) and a value of “19” for the block counter (which may be 8 bits). It should be noted that each packet may or may not be encrypted, however the encryption resolution preferably will be at a MAC packet level. Thus, an encrypted packet may be followed by an unencrypted packet and the transmitting of the unencrypted packet would not need to increment the state of the counters.

Thus, when using the above IV, for a given packet, each subsequent 128-bit partition will be XORed with a key stream that began as the IV (which was determined by the appropriate incrementing/resetting of the various counters) and was processed through the encryption algorithm. It should be noted that incrementing of the various counters can be as desired and may, for example, involve addition or subtraction of a predetermined value in a predetermined pattern. In other words, each counter may changes states based on, for example, the number and type of packets that are sent and a predetermined pattern. Furthermore, the size of the counters may be adjusted so as to provide the desired number of blocks per MAC level packet, the number of MAC packets per upper level packet, and the number of upper level packets.

Thus as depicted, for a given random nonce value, a maximum MAC layer packet size may be about 2 kilobits, a maximum upper level packet size may be about 1 megabyte and a maximum number of upper-level packets may be 4 billion. Other values are also possible and, for example, the size of the MAC layer packet may be increased or limited to something less, depending on the amount of buffer space that is desired to be used. One advantage of this system is because the random nonce can be stored in the memory of the devices in communication, the random nonce does not need to be transmitted with each packet sent, reducing the transmission overhead while still providing a relatively secure encryption for a significant number of upper level packets per random nonce. Furthermore, if the random nonce is XOR with the device address, then a single random nonce may be used with a number of polled devices in a point to multipoint transmission. As can be appreciated, as the upper limit of the of the MAC layer packet decreases, the overhead of transmitting a random nonce becomes proportionally greater and the ability to not include it in the transmission become more valuable.

While a significant number of upper level packets can utilize the same random nonce, the random nonce can also be changed as desired and can be communicated by means of a SESSION_REFRESH PDU, as discussed above. The random nonce may also be changed if the random nonce for the session is set through the ULIF layer. The random nonce may also be changed as part of an error recovery process, if for example, packets are lost and two devices lose synchronization. The random nonce may also be reset in a situation where the polling device sets up a multi-peer network, possibly with a group key for all the devices. As can be appreciated, the random nonce may also be reset for other reasons, including the passage of time, etc . . . .

While 128-bit encryption with a tested algorithm such as AES-CTR provides an acceptable level of encryption for most applications, variations are possible. For example, 192-bit encryption would be possible with the depicted system in conjunction with a 128-bit random nonce and 256-bit encryption would be possible with a 192-bit random nonce (or an appropriate change in the size of the counters). Smaller and less secure encryption is also possible. For example, the 64-bit random nonce could be XOR with the 64-bit set of counters to form a 64-bit IV as depicted in FIG. 13a. Naturally, other variations are also possible (by XORing a portion of the random nonce with a portion of the counters). However, given the current trends in increases in computational power, it is not recommended that less than 64-bits be used.

As noted above, while a block cipher algorithm, such as the AES-CTR algorithm, can provide good confidentiality, it does not resolve issues of authentication and integrity. Indeed, it is considered relatively straightforward to use a valid ciphertext to forge other ciphertext that appear valid to the decryptor. Generally speaking, therefore, it is recommended that encryption algorithms be used with some sort of authentication algorithm such as HMAC-SHA.

In an embodiment, an additional set of bytes could be included in the packet to provide for the authentication and integrity of the packet using a known authentication algorithm. In an alternative embodiment, however, to reduce the transmission of bytes, the 16-bit CRC depicted in FIG. 8, which is used to detect errors in the transmission and may be the CRC16 CCITT algorithm, can be replaced with a 16 bit CRC based message authentication code or ICV₁₆ when ciphertext is transmitted, as also depicted in FIG. 8 so as to provide a combination of error detection and authentication without requiring an increase in the number of bits being transmitted.

In an embodiment, the ICV₁₆ may be generated as follows. First an IV with a zero-value block counter may be processed in the encryption algorithm to form a first key stream. The first two bytes of the first vector (the two most significant bytes) may be used to generate a polynomial p(x), however, to improve error correction properties the first degree of x in the polynomial may be set to 1. For example:

$$P ( x ) = {\sum }_{i = 0}^{16} {p}_{j} {x}^{i} ; for {P}_{0 , 2 … 16} , and {P}_{1} = 1$$

Thus, the first two bytes can be used to provide a value for the first 15 bits (most significant bit being used for the corresponding most significant bit), 1 can be used for the value of X¹ bit and then the least significant value of the first two bytes can be used for the x⁰ value of the polynomial p(x). As can be appreciated, variations in determining the polynomial p(x) based on the key stream are possible. In addition, the last two bytes of the first key stream (the least significant bytes of the key stream) may be used as k (to be used as a one time pad). Both the p(x) and the k need to be shared a priori between the message authentication code originator and the verifier. However, if the originator and the verifier can determine the first key stream ahead of time (which is possible because the next state of the counters can be determined based on the current state of the counters and the header bits and the predetermined pattern of state change), the values for p(x) and k can be computed ahead of time. Then, for a b-bit message B (which, as discussed above, may be the ciphertext payload), the following notation may be used:

Associate B=B_{b-1} . . . B₁, B₀ with the polynomial

$$B ( x ) = {\sum }_{i = 0}^{b - 1} {B}_{i} {x}^{i}$$

Then compute:

d(x)=coef(B(x)*x^{m} mod 2 p(x))

to obtain the m-bit (m=16 in the present example) string of coefficients from the degree m remainder polynomial after dividing B(x)*x^{m} by p(x). A vector i₁₆ is then set equal to the coefficients of the remainder. Then the ICV₁₆ value for the message B is i₁₆ XOR k. Thus, the operation of the algorithm is essentially a binary polynomial division of the message B by p(x) followed by an XOR of the resultant coefficient with a one-time code k where p(x) is based on the most significant two bytes of the key stream associated with the zero-value block counter and k is based on the least two significant bytes of the key stream associated with the zero-value block counter. Of course, the key stream associated with a one-value block counter could also be used as to provide the p(x) and k values as there would be no need for the ICV₁₆ if there was not at least a partial block of ciphertext. However, if the packet is not encrypted (e.g., the security bit is 0) then there is no need for the ICV₁₆ and the normal CRC may be used.

As can be appreciated, the above method of calculating the ICV₁₆ allows for a reasonably rapid calculation so as to provide for a timely ACK/NACK response. As the first and last packet of an upper-level packet are identified by the header bits, the next IV to be used with a specific counterpart can be uniquely identified from any packet in the sequence and key stream for the IV with the zero value counter block can be predetermined. Thus, if p(x) and k are pre-computed, the computation of the ICV₁₆ can be done in substantially real time. As can be appreciated, depending on the size of the key stream and the desired size of p(x) and k, different portions of the key stream may be used to generate the p(x) and k values. It should be noted that while stronger integrity levels and error detection levels are possible if an authentication algorithm was used in combination with the CRC, the level of integrity and error detection afforded by replacing the CRC with the ICV₁₆ provides a suitable tradeoff between protecting against known-plaintext attacks and interference and transmission errors while minimizing transmission power requirements.

Thus, the encrypted data PDU may be sent with minimal overhead versus a non-encrypted packet. As is known, encryption algorithms such as the AES algorithm can be accomplished using a look-up table. In an embodiment, a hardware (HW) module may also be used to process the IV with a encryption algorithm such as the AES algorithm in a known manner. Thus, security can be provided on a chip without the need for significant cost or significant higher layer involvement.

It should be further noted that the ICV₁₆ uses substantially the same algorithm as the CRC16 CCITT algorithm discussed above. Therefore, it is possible to use the same logic hardware to perform portions of both the CRC16 CCITT and the ICV₁₆ algorithms. In an integrated circuit, this allows for further reduction in hardware complexity and cost by allowing both algorithms to use the same configurable CRC-block for the polynomial division.

In addition, to provide for a certain level of error correction, 4 different sets hardware modules could be provided to allow for simultaneous evaluation of the received CRC/ICV. In an embodiment, each hardware module could process the received packet with a different value for the packet counter (e.g., x, x+1, x+2, and x+3, where x is either equal to the current value of the packet counter or the equal to the current value minus y—where y is 1, 2 or 3). As can be appreciated, such a configuration would allow the device to receive a packet even if up to three packets had been missed. Therefore, less resetting of the random nonce would be necessary because it would be less likely for two devices to loose synchronization. In addition, as such an implementation could be implemented in the hardware device without greatly increasing the cost of the device, it would provide for a cost effective and efficient method to reduce retransmission of packets and/or the random nonce. Naturally, more or less hardware blocks could be added as desired.

However, it is expected that certain amount of re-syncronization of the IV may be required. For example, if an encrypted packet cannot be received, then a new nonce may be provided via the Session_Refresh control packet and the states of the counters can be reset. To improve security, the Session_Refresh packet may be sent after the poller device enters a whisper or reduced power mode so as to provide greater security for the transmission of the nonce.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We Claim:

1. A method for using a baseband level in a device to provide secure data via wireless transmission, the method comprising:
(a) calculating a first value for an initiation vector (IV) based on a received nonce and a counter state;
(b) using the IV to generate a first key stream;
(c) transmitting a first packet that includes ciphertext formed with the first key stream, wherein the first packet does not include the nonce;
(d) calculating a second value of the IV based on the received nonce and a first incremented counter state;
(e) if the first packet was successfully received,
(i) using the second value of the IV to generate a second key stream; and
(ii) transmitting a second packet including ciphertext formed by the second key stream, wherein the second packet does not include the nonce; and
(f) if the first packet was not successfully received, re-synchronizing the IV.

2. The method of claim 1, wherein the received nonce in (a) comprises a 64-bit random nonce XORed with an address of the device, wherein the 64-bit random nonce is determined by an upper level layer that is communication with the baseband layer of the device.

3. The method of claim 1, wherein the transmitting in (c) further comprises:
(i) forming an integrity check value (ICV); and
(ii) adding the ICV to the packet, the ICV replacing a cyclic redundancy check.

4. The method of claim 3, wherein the ICV is based on a third key stream generated by a third value of the IV.

5. The method of claim 4, wherein the forming in (i) comprises
(1) performing mod 2 division of a message with a polynomial based on two most significant bytes of the third key stream to generate a coefficient vector; and
(2) XORing the coefficient vector with two least significant bytes of the third key stream to form the ICV.

6. The method of claim 1, wherein the re-synchronizing of the IV in (f) comprises receiving a new nonce thorough wireless transmission and resetting the counter state.

7. The method of claim 6, wherein the receiving of the new nonce includes receiving a signal from a poller device that is transmitted with reduced power.

8. The method of claim 1, wherein the re-synchronizing of the IV in (f) comprises:
(i) calculating at least one additional IV based on at least one additional incremental counter state;
(ii) using the at least one additional IV to generate at least one key stream; and
(iii) transmitting at least one additional packet, wherein the at least one additional packets respectively uses the at least one key stream to encrypt the packet, and wherein an acknowledgement that the at least one additional packets has been received is used to update the state of the counters based on the counters state used for the IV associated with the packet that was received.

9. The method of claim 1, wherein the counter comprises a set of counters including a block counter, a packet counter and an upper level packet counter.

10. The method of claim 9, wherein the block counter comprises 8 bits, the packet counter comprises 8 bits and the upper level packet counter comprises 39 bits, and the set of counters further comprises a 1-bit direction counter.

11. A radio module for wireless communication of secure data, comprising:
a transceiver configured to transmit and receive data; and
a component configured to implement a Medium Access Control (MAC), wherein the component includes a processor and a memory, and wherein the memory stores computer-executable instructions for causing the processor to perform the steps of:
(a) receiving a nonce from a poller device;
(b) determining a first value for an initiation vector (IV) based on the nonce and a set of counter states;
(c) generating a first key stream associated with the IV;
(d) providing instructions to transmit a first packet that includes ciphertext encrypted with the first key stream;
(e) determining a second value of the IV based on the received nonce and an incremented set of counter states;
(f) if the first packet was successfully received:
(i) using the second value of the IV to generate a second key stream; and
(ii) providing instructions to transmit a second packet including ciphertext formed by the second key stream, wherein the second packet does not include the nonce; and
(g) if the first packet was not successfully received, re-synchronizing the IV.

12. The radio module of claim 11, wherein the instructions in (d) further comprise:
(i) replacing a cyclic redundancy check with an integrity check value (ICV).

13. The radio module of claim 12, wherein the instructions for the replacing in (i) comprises:
(1) determining a third key stream based on a third value of the IV; and
(2) generating the ICV based on bits selected from the third key stream, wherein the third key stream is generated before the second key stream.

14. The radio module of claim 13, wherein the instructions for generating in (2) is done by dividing the message with a polynomial based on two bytes selected from the third key stream, and wherein the quotient of the division is XOR with two other bytes of the key stream.

15. The radio module of claim 11, wherein the re-synchronizing of the IV in (f) comprises receiving a new nonce thorough wireless transmission and reseting the counter state.

16. A security module for encryption of plaintext in a device, the module comprising:
a component configured to encrypt plaintext with an encryption algorithm in a baseband layer,
wherein the component includes a processor and a memory, wherein the memory stores computer-executable instructions for causing the processor to perform the steps of:
(a) calculating a first value for an initiation vector (IV) based on a nonce and a counter state;
(b) using the IV to generate a first key stream;
(c) providing instructions to transmit a first packet that include ciphertext formed with the first key stream, wherein the first packet does not include the nonce;
(d) calculating a second value of the IV based on the received nonce and an incremented counter state;
(e) if the first packet was successfully received,
(i) using the second value of the IV to generate a second key stream; and
(ii) providing an instruction to transmit a second packet including ciphertext formed by the second key stream, wherein the second packet does not include the nonce; and
(f) if the first packet was not successfully received, re-synchronizing the IV.

17. The security module of claim 16, wherein the memory includes instructions for causing the processor to perform the steps of:
(g) forming an integrity check value (ICV); and
(h) adding the ICV to the first packet, the ICV replacing a cyclic redundancy check.

18. The security module of claim 16, wherein the encryption algorithm is an Advanced Encryption Standard cipher running in counter mode.

19. The security module of claim 18, wherein the component comprises a hardware AES module for transforming the IV to the key stream.

20. The security module of claim 16, wherein the re-synchronizing of the IV in (f) comprises receiving a new nonce thorough wireless transmission and reseting the counter state

21. A method of providing secure wireless transmission in a baseband level, comprising:
(a) generating a first and a second initiation vector (IV) based on a received nonce and a first and second set of counter states;
(b) determining a first integrity check value (ICV) based on a first key stream generated with the first initiation vector;
(c) transmitting a first packet with ciphertext formed by a second key stream generated with the second IV, the packet including the first ICV and omitting the nonce;
(d) generating a third and fourth IV based on the nonce and a third and fourth set of counter states;
(e) if the first packet was received,
(i) determining a second ICV based on a third key stream generated with the third IV; and
(ii) transmitting a second packet with ciphertext based on a fourth key stream generated with the fourth IV, wherein the second packet includes the second ICV and does not include the nonce; and
(f) if the first packet was not received, re-synchronizing the IV.

22. The method of claim 21, wherein the transmitting in (c) comprises:
(i) replacing a cyclic redundancy check (CRC) with the ICV.

23. The method of claim 22, wherein the ICV is generated using the logic block that is used to form the CRC.

24. A method of wirelessly receiving a packet with an encrypted payload, comprising:
(a) generating a key stream with an initiation vector (IV) based on a nonce and a set of counters in an initial state, wherein one of the set of counters is a packet counter and another of the set of counter is a block counter, wherein the block counter is one of a zero value and an one value;
(b) determining whether an ICV included in the packet matches an expected ICV value based on the key stream;
(c) if the ICV matches the expected ICV value for the initial state of counters, encrementing the state of the set of counters based on the IV used to form the key stream; and
(d) if the ICV does not match the expect ICV value, re-synchronizing the IV.

25. The method of claim 24, wherein the key stream is a first key stream and the generating in (a) provides a plurality of key streams, wherein each key stream is based on an incremented value of the packet counter, and wherein the determining in (b) checks the ICV from the received packet using each of the plurality of key streams.

26. The method of claim 25, wherein the determining in (b) is done in a parallel manner so as to allow substantially real time checking of the ICV with each of the plurality of key streams.
